(19) United States
(12) Patent Application Publication
(10) Pub. No.: US 2015/0220171 A1
(43) Pub. Date: Aug. 6, 2015

(54) METHOD FOR PROCESSING INPUT AND ELECTRONIC DEVICE THEREOF

(71) Applicant: Samsung Electronics Co., Ltd., Suwon-si (KR)

(72) Inventor: Young-Chan CHO, Yongin-si (KR)

(21) Appl. No.: 14/613,694

(22) Filed: Feb. 4, 2015

(30) Foreign Application Priority Data
Feb. 6, 2014 (KR) 10-2014-0013632

(51) Int. Cl. G06F 3/041

(52) U.S. Cl. CPC G06F 3/041; G06F 2203/04108

(57) ABSTRACT

A method for operating of an electronic device is provided. The method includes detecting hovering which is input to a touch panel including a curved surface, determining space coordinates corresponding to the hovering, and displaying an image corresponding to the space coordinates on a display.

### CROSS-REFERENCE TO RELATED APPLICATION(S)

This application claims the benefit under 35 U.S.C. §119(a) of a Korean patent application filed on Feb. 6, 2014 in the Korean Intellectual Property Office and assigned Serial No. 10-2014-0013632, the entire disclosure of which is hereby incorporated by reference.

### TECHNICAL FIELD

The present disclosure relates to a method for processing a hovering input on a designated space in an electronic device, and an electronic device thereof.

### BACKGROUND

With the development of technology, displays included in electronic devices can have curved surfaces and furthermore can be bent according to user's selection.

By means of a touch panel mounted in the electronic device, a user can input a command not only by physically touching a surface of the touch panel with an inputting means but also by placing the inputting means a designated distance (length) away from the touch panel (for example, hovering).

The touch panel may be included in a designated location of the electronic device. Furthermore, a touch screen functionally combined with the display may display contents of the electronic device, and the user may input a command on a selected content by touching the touch screen or hovering above the touch screen with the inputting means.

The above information is presented as background information only to assist with an understanding of the present disclosure. No determination has been made, and no assertion is made, as to whether any of the above might be applicable as prior art with regard to the present disclosure.

### SUMMARY

In inputting a three-dimensional (3D) image, the electronic device sets a 3D coordinate system on the touch panel which is formed in two dimensions. Thus, the electronic device may reduce the realism of the 3D image and may cause distortion of an input image.

Aspects of the present disclosure are to address at least the above-mentioned problems and/or disadvantages and to provide at least the advantages described below. Accordingly, an aspect of the present disclosure is to provide a method for directly inputting a 3D image based on a designated input device in an electronic device.

In accordance with an aspect of the present disclosure, a method for operating of an electronic device is provided. The method includes detecting hovering which is input to a touch panel including a curved surface, determining space coordinates corresponding to the hovering, and displaying an image corresponding to the space coordinates on a display.

In accordance with another aspect of the present disclosure, an electronic device is provided. The electronic device includes a touch panel configured to detect hovering, a display configured to display space coordinates corresponding to the hovering, a memory configured to store information on the hovering, and at least one processor configured to detect the hovering which is input to the touch panel including a curved surface, determine the space coordinates corresponding to the hovering, and display an image corresponding to the space coordinates on the display.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a network environment including an electronic device according to various embodiments of the present disclosure;

FIG. 2 illustrates a block diagram of an input processing module included in an electronic device according to various embodiments of the present disclosure;

FIG. 3 illustrates a block diagram of an electronic device according to various embodiments of the present disclosure;

FIGS. 4A and 4B illustrate a method for detecting hovering in a curved display of an electronic device according to various embodiments of the present disclosure;

FIG. 5 illustrates a method for detecting space coordinates corresponding to hovering in a curved display of an electronic device according to an embodiment of the present disclosure;

FIG. 6 illustrates a method for detecting space coordinates corresponding to hovering in a curved display of an electronic device according to an embodiment of the present disclosure;

FIGS. 7A and 7B illustrate a method for detecting space coordinates corresponding to hovering when coordinates are designated on a display of an electronic device according to various embodiments of the present disclosure;

FIGS. 8A and 8B illustrate a configuration of a device for determining space coordinates of an inputting means when the inputting means is located in a designated space formed by a display of an electronic device according to various embodiments of the present disclosure;

FIG. 9 illustrates an operation of displaying a trajectory drawn by space coordinates input through a display of an electronic device according to an embodiment of the present disclosure;

FIG. 10 illustrates a flowchart showing an operation of processing hovering which is input to a space formed by a display of an electronic device according to various embodiments of the present disclosure;

FIG. 11 illustrates a flowchart showing an operation of processing hovering which is input to a space formed by a display of an electronic device according to various embodiments of the present disclosure; and

FIG. 12 illustrates a flowchart showing an operation of processing hovering which is input to a space formed by a display of an electronic device according to various embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The terms “include” or “may include” used in various embodiments of the present disclosure indicate the presence of disclosed corresponding functions, operations, elements, and the like, and do not limit one or more additional functions, operations, elements, and the like. In addition, it should be understood that the terms “include” or “have” used in various embodiments of the present disclosure are to indicate the presence of features, numbers, steps, operations, elements, parts, or a combination thereof described in the specifications, and do not preclude the presence or addition of one or more other features, numbers, steps, operations, elements, parts, or a combination thereof.

The term “or” used in various embodiments of the present disclosure includes any and all combinations of words enumerated with it. For example, “A or B” means including A, including B, or including both A and B.

Although the terms such as “first” and “second” used in various embodiments of the present disclosure may modify various elements of the present disclosure, these terms do not limit an order and/or importance of the corresponding elements. In addition, these terms may be used for the purpose of distinguishing one element from another element.

It will be understood that when an element is mentioned as being “connected” or “coupled” to another element, the element may be directly connected or coupled to the other element, and there may be an intervening element between the element and the other element. To the contrary, it will be understood that when an element is mentioned as being “directly connected” or “directly coupled” to another element, there is no intervening element between the element and the other element.

The terms used in various embodiments of the present disclosure are for the purpose of describing various embodiments only and are not intended to limit the present disclosure. In addition, all of the terms used herein including technical or scientific terms have the same meanings as those generally understood by an ordinary skilled person in the related art unless they are defined otherwise, and should not be interpreted as having ideal or exaggerated meanings unless they are clearly defined in the various embodiments of the present disclosure.

An electronic device according to various embodiments of the present disclosure may be a device which is equipped with a communication function. For example, the electronic device may include at least one of various devices which include a communication function, such as a smartphone, a tablet personal computer (PC), a mobile phone, a video phone, an electronic book reader, a desktop PC, a laptop PC, a netbook computer, a Personal Digital Assistant (PDA), a Portable Multimedia Player (PMP), an MP3 player, a mobile medical machine, a camera, a wearable device (for example, a Head Mounted Device (HMD) such as electronic glasses, electronic clothing, an electronic bracelet, an electronic necklace, an electronic appcessory, electronic tattoos, or a smart watch), a television (TV), a Digital Video Disk (DVD) player, a stereo, a refrigerator, an air conditioner, a cleaner, an oven, a microwave oven, a washing machine, an air cleaner, a set-top box, a TV box (for example, Samsung HomeSync™, Apple TV™, or Google TV™), a game console, an electronic dictionary, an electronic key, a camcorder, a medical machine (for example, Magnetic Resonance Angiography (MRA), Magnetic Resonance Imaging (MRI), Computerized Tomography (CT), a tomograph, an ultrasound machine, and the like), a navigation device, a Global Positioning System (GPS) receiver, an Event Data Recorder (EDR), a Flight Data Recorder (FDR), an automotive infotainment device, electronic equipment for ship (for example, navigation equipment for ship, a gyro compass, and the like), avionics, a security device, an industrial or home robot, a part of furniture or a building/a structure, an electronic board, an electronic signature receiving device, a projector, or various measurement devices (for example, water, power, gas, radio waves, and the like). The electronic device according to various embodiments of the present disclosure may be one of the above-mentioned devices or a combination of one or more of the above-mentioned devices. In addition, it is obvious to an ordinary skilled person in the related art that the electronic device according to various embodiments of the present disclosure is not limited to the above-mentioned devices.

Hereinafter, an electronic device according to various embodiments of the present disclosure will be explained with reference to the accompanying drawings. The term “user” used in various embodiments of the present disclosure may refer to a person who uses the electronic device or a device that uses the electronic device (for example, an artificial intelligence electronic device).

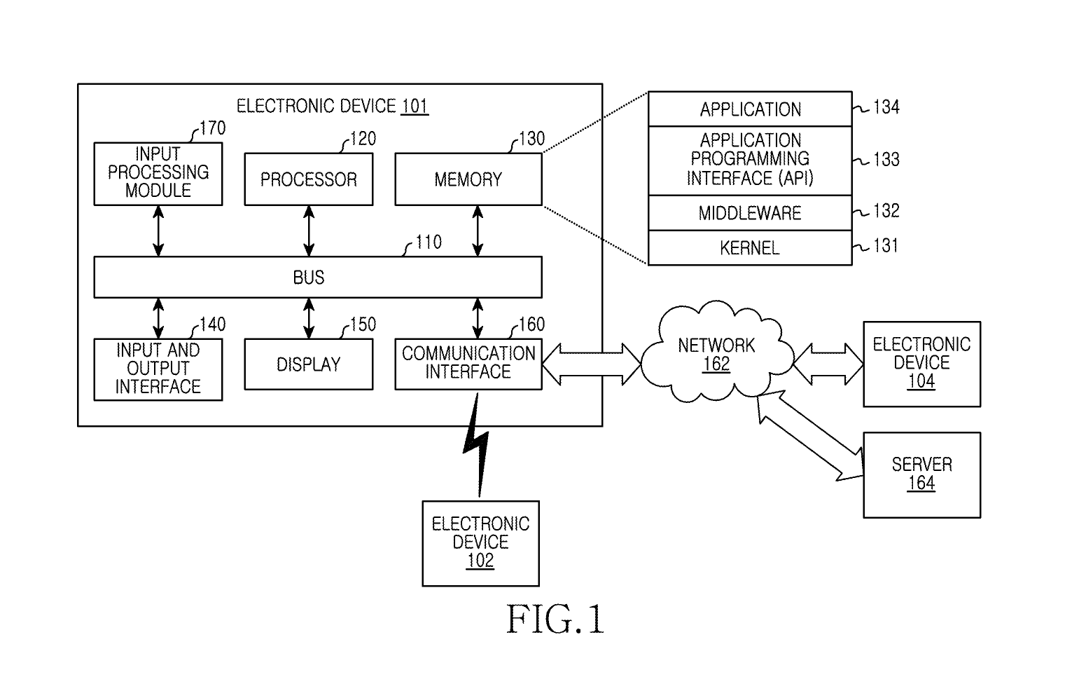

FIG. 1 illustrates a network environment including an electronic device according to various embodiments of the present disclosure.

Referring to FIG. 1, the electronic device 101 may include a bus 110, a processor 120, a memory 130, an input and output interface 140, a display 150, a communication interface 160, and an input processing module 170.

The bus 110 may be a circuit which connects the above-described elements with one another and transmits communication signals (for example, a control message) between the above-described elements.

The processor 120 may receive instructions from the other elements (for example, the memory 130, the input and output interface 140, the display 150, the communication interface 160, or the input processing module 170) via the bus 110, decipher the instructions, and perform calculation or data processing according to the deciphered instructions.

The memory 130 may store instructions or data which is received from or generated by the processor 120 or the other elements (e.g., the input and output interface 140, the display 150, the communication interface 160, the input processing module 170, and the like). For example, the memory 130 may include programming modules such as a kernel 131, middleware 132, an Application Programming Interface (API) 133, an application 134, and the like. Each of the above-described programming modules may be configured by software, firmware, hardware, or a combination of two or more of them.

The kernel 131 may control or manage system resources (for example, the bus 110, the processor 120, the memory 130, and the like) which are used for performing operations or functions implemented in the other programming modules, for example, the middleware 132, the API 133, or the application 134. In addition, the kernel 131 may provide an interface for allowing the middleware 132, the API 133, or the application 134 to access an individual element of the electronic device 101 and control or manage the element.

The middleware 132 may serve as an intermediary to allow the API 133 or the application 134 to communicate with the kernel 131 and exchange data with the kernel 131. In addition, the middleware 132 may perform controlling (for example, scheduling or load balancing) with respect to work requests received from the application 134, for example, by giving priority to use the system resources of the electronic device 101 (for example, the bus 110, the processor 120, the memory 130, and the like) to at least one of the applications 134.

The API 133 is an interface for allowing the application 134 to control a function provided by the kernel 131 or the middleware 134, and, for example, may include at least one interface or function (for example, instructions) for controlling a file, controlling a window, processing an image, or controlling a text.

The application 134 may be an application related to information exchange between the electronic device 101 and an external electronic device (for example, an electronic device 102 or an electronic device 104). For example, the application related to the information exchange may include a notification relay application for relaying specific information to the external electronic device or a device management application for managing the external electronic device. According to various embodiments of the present disclosure, the application 134 may include an application which is additionally specified according to an attribute (for example, a kind of an electronic device) of the external electronic device (for example, the electronic device 102 or the electronic device 104).

The input and output interface 140 may transmit instructions or data input by the user through a sensor (for example, an acceleration sensor or a gyro sensor) or an input device (for example, a keyboard or a touch screen) to the processor 120, the memory 130, the communication interface 160, or the input processing module 170 through the bus 110, for example. For example, the input and output interface 140 may provide data on a user's touch input through a touch screen to the processor 120. In addition, the input and output interface 140 may output instructions or data received from the processor 120, the memory 130, the communication interface 160, or the input processing module 170 through the bus 110 through an output device (for example, a speaker or a display). For example, the input and output interface 140 may output a result of processing data input to the input device (for example, a touch panel) functionally connected with the input processing module 170 for the user. According to an embodiment of the present disclosure, when the input device detects an inputting means or acquires designated information from the inputting means, the input and output interface 140 may output a vibration of a designated pattern through a vibration motor included in the electronic device 101, or may display information corresponding to the input on a designated area of the display 150. The input and output interface 140 may output a vibration of a designated pattern through the vibration motor regarding a result of processing information (or data) acquired by the input device, or may display the result on a designated area of the display 150.

The display 150 may display a variety of information (for example, multimedia data, text data, and the like) for the user. The display 150 may include a touch screen on which the user inputs a command by touching or hovering above the display with an inputting means. The touch screen may include a touch panel to perform an input function and a display function simultaneously. The touch panel may include a Liquid Crystal Display (LCD) or an Active Matrix Organic Light Emitting Diode (AM-OLED) and may be implemented to be flexible, transparent, or wearable. The touch panel may recognize a touch input in at least one method of capacitive, resistive, infrared, and ultrasonic methods. The touch panel may further include a controller (not shown). In the case of a capacitive method, the touch panel may recognize hovering as well as a direct touch. The hovering may be called a non-contact touch.

The display 150 may be configured in a curved display shape. The curved display 150 may have a curved surface of a designated curvature, and the curvature of the display 150 may be changed according to user's selection. Two or more curvatures may be applied to the curved surface of the single display 150. According to an embodiment of the present disclosure, the touch panel may be implemented to recognize hovering based on the shape of the curved surface of the display 150. The user may hover in a designated space (or a three-dimensional (3D) space) area formed according to the shape of the curved surface of the display 150 (hereinafter, referred to as a designated space of the display 150 or a designated space area of the display 150), and the display 150 may detect a multidimensional input (for example, point, line, surface, space) which is input to a designated location of the above-described space area based on information input to the touch panel. The display 150 may display a result of the multidimensional input to the designated space area of the display 150 through the display 150 or a 3D (for example, a 3D object) output device as a 3D object. The touch panel may further include a tactile layer to provide a tactile response to the user. The touch screen may include a hologram. The hologram may show a 3D object in the air using interference of light. Additionally, the touch screen may further include a control circuit to control the touch panel or the hologram. In the following explanation, the touch screen and the touch panel may indicate the display 150 unless they are specifically distinguished. In addition, the display 150 may have a designated curvature and may be flexible and bendable. In various embodiments of the present disclosure described below, at least one coordinate system corresponding to the display 150 or a designated space formed by the display 150 may be set and explained. The coordinate system is merely an example for the purpose of easy understanding of various embodiments of the present disclosure and the present disclosure is not limited to the coordinate system or coordinates designated in the explanation.

The communication interface 160 may establish communication between the electronic device 101 and an external device (for example, the electronic device 104 or a server 164). For example, the communication interface 160 may be connected to a network 162 via wireless communication or wired communication to communicate with the external device. The wireless communication may include at least one of Wireless Fidelity (Wi-Fi), Bluetooth (BT), Near Field Communication (NFC), GPS, or cellular communication (for example, Long Term Evolution (LTE), LTE-Advanced (LTE-A), Code Division Multiple Access (CDMA), Wideband CDMA (WCDMA), Universal Mobile Telephone System (UMTS), Wireless Broadband (WiBro), Global System for Mobile Communications (GSM), and the like). The wired communication may include at least one of a Universal Serial Bus (USB), a High Definition Multimedia Interface (HDMI), a Recommended Standard 232 (RS-232), or a Plain Old Telephone Service (POTS).

According to an embodiment of the present disclosure, the network 162 may be a telecommunications network. The telecommunications network may include at least one of a computer network, the Internet, Internet of things, or a telephone network. According to an embodiment of the present disclosure, a protocol for communicating between the electronic device 101 and the external device (for example, a transport layer protocol, a data link layer protocol or a physical layer protocol) may be supported in at least one of the application 134, the API 133, the middleware 132, the kernel 131, or the communication interface 160.

The input processing module 170 may detect hovering which is input to a touch panel including a curved surface, determine space coordinates corresponding to the hovering, and display an image corresponding to the space coordinates on a display.

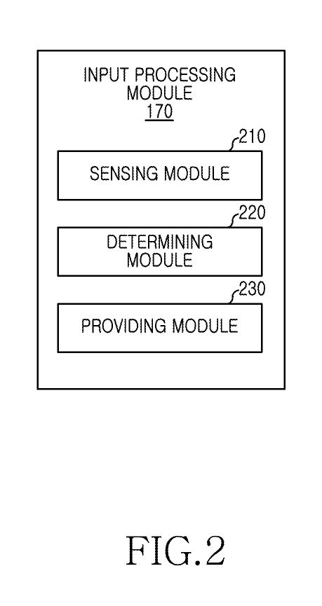

The input processing module 170 may control to detect an inputting means which is located in a designated space area formed based on the touch panel. The input processing module 170 may detect an input of the inputting means which is drawn in the designated space area formed based on the touch panel. The input processing module 170 may determine the space coordinates based on at least one coordinate located on a coordinate system set on the touch panel, and a length from a surface of the touch panel to the inputting means. The input processing module 170 may determine the space coordinates based on two or more coordinates which have a same corresponding value on at least one coordinate axis in a coordinate system set on the touch panel. The input processing module 170 may set a virtual plane having at least one coordinate axis with reference to the space coordinate in a designated space formed by the touch panel. When the inputting means which hovers is moved, the inputting processing module 170 may determine a location of the moved inputting means according to displacement in a coordinate system set on the plane with reference to the space coordinates. The input processing module 170 may display the image along a line connecting the two or more space coordinates. The input processing module 170 may determine the space coordinates by transmitting a first signal and a second signal through the touch panel, receiving a third signal and a fourth signal which are changed from the first signal and the second signal by the inputting means, respectively, through the touch panel, and comparing the third signal and the fourth signal to determine a gap between the third signal and the fourth signal. The input processing module 170 may transmit the first signal and the second signal which are of different patterns serially. The input processing module 170 may transmit the first signal at a first angle and transmit the second signal at a second angle. When the inputting means which hovers is moved, the input processing module 170 may display a trajectory connecting the two or more space coordinates. The input processing module 170 may display the space coordinates and the trajectory connecting the two or more space coordinates as a 3D image. The input processing module 170 may display the space coordinates and the trajectory connecting the two or more space coordinates as a hologram. The operation of the input processing module 170 may be performed by one or more processor 120, or may be performed by the input processing module 170 based on control of the processor. Additional information on the input processing module 170 will be provided with reference to FIGS. 2 to 12 described below. 100521 FIG. 2 illustrates a block diagram of an input processing module 170 of an electronic device (for example, the electronic device 101) according to various embodiments of the present disclosure.

Referring to FIG. 2, the input processing module 170 may include one or more of a sensing module 210, a determining module 220, and a providing module 230.

The sensing module 210 may detect hovering which is input to a touch panel (hereinafter, referred to as the display 150) of the display 150. The sensing module 210 may detect an inputting means hovering above the display 150 having a curved surface and a designated space (hovering area) formed by the display 150. The sensing module 210 may determine space coordinates of a location where the inputting means hovers through a coordinate system which includes at least one coordinate axis set on the display 150. In detecting the space coordinates of the location where the inputting means hovers, the sensing module 210 may detect coordinates on various components of the coordinate system set on the display 150.

The determining module 220 may determine a 3D image based on the space coordinates of the inputting means which hovers above the display 150. According to an embodiment of the present disclosure, the determining module 220 may determine at least one space coordinate corresponding to hovering which is input to the hovering area and may determine a 3D image according to a trajectory connecting two or more space coordinates.

The providing module 230 may display the 3D image which is determined based on the hovering input to the display 150. According to an embodiment of the present disclosure, in providing the determined 3D image, the providing module 230 may display the 3D image on the space area which is displayed to represent a sense of depth of the display 150 or may display the 3D image as a hologram through the display 150 which can display the hologram.

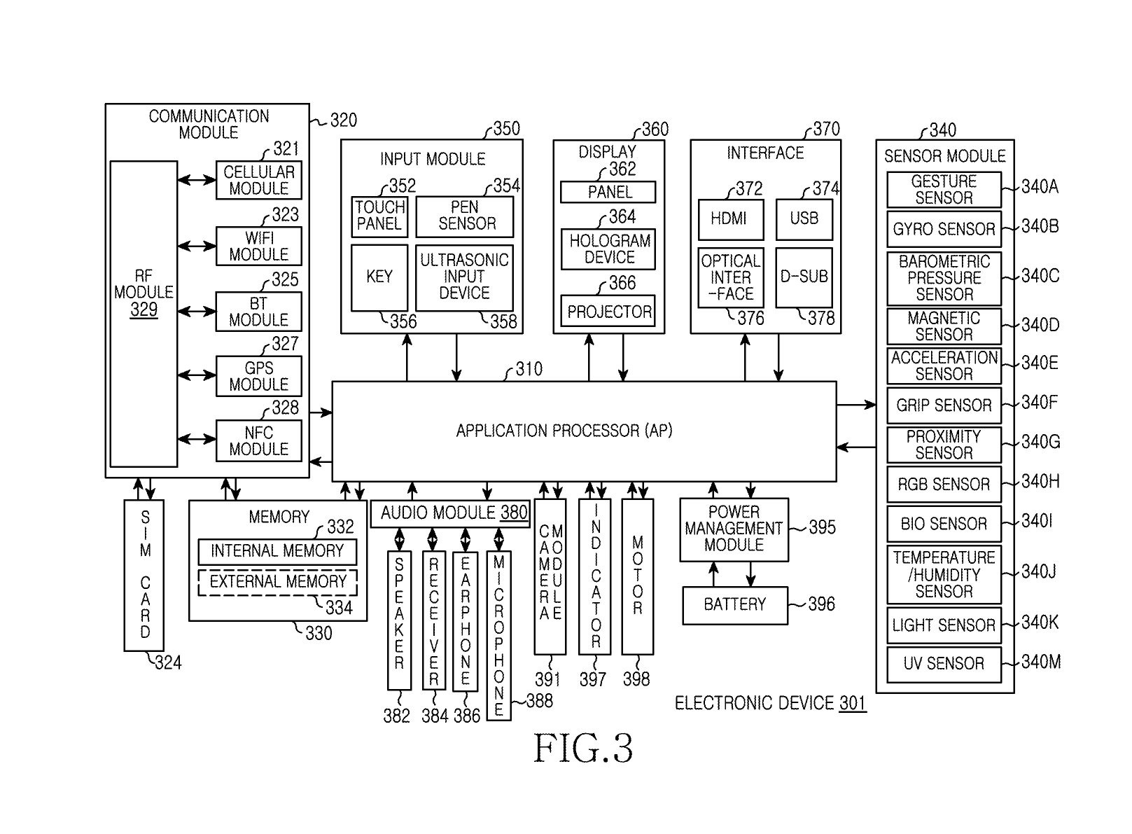

FIG. 3 illustrates a block diagram of an electronic device according to various embodiments of the present disclosure. The electronic device 301 may configure an entirety or part of the electronic device 101 shown in FIG. 1.

Referring to FIG. 3, the electronic device 301 may include one or more Application Processors (APs) 310, a communication module 320, a Subscriber Identification Module (SIM) card 324, a memory 330, a sensor module 340, an input device 350, a display 360, an interface 370, an audio module 380, a camera module 391, a power management module 395, a battery 396, an indicator 397, or a motor 398.

The AP 310 may control a plurality of hardware or software elements connected to the AP 310 by driving an operating system or an application program, and may process and calculate a variety of data including multimedia data. For example, the AP 310 may be implemented by using a System on Chip (SoC). According to an embodiment of the present disclosure, the AP 310 may further include a Graphics Processing Unit (GPU) (not shown).

The communication module 320 (for example, the communication interface 160) may transmit and receive data in communication between the electronic device 301 (for example, the electronic device 101) and other electronic devices (for example, the electronic device 104 or the sever 106) connected through a network. According to an embodiment of the present disclosure, the communication module 320 may include a cellular module 321, a Wi-Fi module 323, a BT module 325, a GPS module 327, an NFC module 328, and a Radio Frequency (RF) module 329.

The cellular module 321 may provide a voice call, a video call, a text service, or an interne service through a telecommunications network (e.g.: LTE, LTE-A, CDMA, WCDMA, UMTS, WiBro, GSM, and the like). In addition, the cellular module 321 may identify and authenticate the electronic device in the telecommunications network by using a SIM (for example, the SIM card 324). According to an embodiment of the present disclosure, the cellular module 321 may perform at least some functions provided by the AP 310. For example, the cellular module 321 may perform at least some of the multimedia control functions.

According to an embodiment of the present disclosure, the cellular module 321 may include a Communication Processor (CP). In addition, the cellular module 321 may be implemented by using an SoC, for example. In FIG. 3, the cellular module 321 (for example, the communication processor), the memory 330, or the power management module 395 are elements separate from the AP 310. However, according to an embodiment of the present disclosure, the AP 310 may be configured to include at least some of the above-described elements (for example, the cellular module 321).

According to an embodiment of the present disclosure, the AP 310 or the cellular module 321 (for example, the communication processor) may load instructions or data received from a non-volatile memory connected therewith or at least one of the other elements into a volatile memory, and may process the instructions or data. In addition, the AP 310 or the cellular module 321 may store data which is received from at least one of the other elements or generated by at least one of the other elements in the non-volatile memory.

The Wi-Fi module 323, the BT module 325, the GPS module 327, or the NFC module 328 each may include a processor for processing data received and transmitted through a corresponding module. In FIG. 3, the cellular module 321, the WiFi module 323, the BT module 325, the GPS module 327, or the NFC module 328 is illustrated in a separate block. However, according to an embodiment of the present disclosure, at least some (for example, two or more) of the cellular module 321, the WiFi module 323, the BT module 325, the GPS module 327, or the NFC module 328 may be included in a single integrated chip (IC) or a single IC package. For example, at least some of the processors corresponding to the cellular module 321, the WiFi module 323, the BT module 325, the GPS module 327, and the NFC module 328 (for example, the communication processor corresponding to the cellular module 321 and the WiFi processor corresponding to the WiFi module 323) may be implemented by using a single SoC.

The RF module 329 may transmit and receive data, for example, may transmit and receive an RF signal. Although not shown, the RF module 329 may include a transceiver, a Power Amplifier Module (PAM), a frequency filter, or a Low Noise Amplifier (LNA), for example. In addition, the RF module 329 may further include a part for exchanging electromagnetic waves in a free space in wireless communication, for example, a conductor or conducting wire. In FIG. 3, the cellular module 321, the Wi-Fi module 323, the BT module 325, the GPS module 327, and the NFC module 328 share the single RF module 329 with one another. However, according to an embodiment of the present disclosure, at least one of the cellular module 321, the Wi-Fi module 323, the BT module 325, the GPS module 327, or the NFC module 328 may transmit and receive an RF signal through a single separate RF module.

The SIM card 324 may be a card including a subscriber identification module, and may be inserted into a slot formed on a specific location of the electronic device. The SIM card 324 may include its unique identification information (for example, an Integrated Circuit Card Identifier (ICCID)) or subscriber information (for example, International Mobile Subscriber Identity (IMSI)).

The memory 330 (for example, the memory 130) may include an internal memory 332 or an external memory 334. For example, the internal memory 332 may include at least one of a volatile memory (for example, a Dynamic Random Access Memory (DRAM), a Static RAM (SRAM), a Synchronous DRAM (SDRAM), and the like) and a non-volatile memory (for example, an One-Time Programmable Read Only Memory (OTPROM), a Programmable ROM (PROM), an Erasable PROM (EPROM), an Electrically Erasable PROM (EEPROM), a mask ROM, a flash ROM, a Not And (NAND) flash memory, a Not Or (NOR) flash memory, and the like).

According to an embodiment of the present disclosure, the internal memory 332 may be a Solid State Drive (SSD). The external memory 334 may further include a flash drive, for example, Compact Flash (CF), Secure Digital (SD), Micro-SD, Mini-SD, extreme-Digital (xD), memory stick, and the like. The external memory 334 may be functionally connected with the electronic device 301 through various interfaces. According to an embodiment of the present disclosure, the electronic device 301 may further include a storage device (or a storage medium) such as a hard drive.

The sensor module 340 may measure a physical quantity or detect an operation state of the electronic device 301, and may convert measured or sensed information into electric signals. The sensor module 340 may include at least one of a gesture sensor 340A, a gyro sensor 340B, a barometric pressure sensor 340C, a magnetic sensor 340D, an acceleration sensor 340E, a grip sensor 340F, a proximity sensor 340G, a color sensor 340H (e.g., Red, Green, Blue (RGB) sensor), a biosensor 340I, a temperature/humidity sensor 340J, an illumination sensor 340K, and a Ultraviolet (UV) sensor 340M. Additionally or alternatively, the sensor module 340 may include an E-nose sensor (not shown), an electromyography (EMG) sensor (not shown), an electroencephalogram (EEG) sensor (not shown), an electrocardiogram (ECG) sensor (not shown), an infrared ray (IR) sensor, an iris sensor (not shown), a fingerprint sensor, and the like. The sensor module 340 may further include a control circuit to control at least one sensor included therein.

The input device 350 may include a touch panel 352, a (digital) pen sensor 354, a key 356, or an ultrasonic input device 358. The touch panel 352 may recognize a touch input in at least one method of capacitive, resistive, infrared, and ultrasonic methods. In addition, the touch panel 352 may further include a control circuit (not shown). In the embodiment of a capacitive method, the touch panel 352 may recognize not only physical contact but also approach. The touch panel 352 may further include a tactile layer. In this embodiment of the present disclosure, the touch panel 352 may provide a tactile response to the user.

The (digital) pen sensor 354 may be implemented in the same or similar method as or to the method of receiving a user's touch input or by using a separate detection sheet. The key 356 may include a physical button, an optical key, or a keypad. The ultrasonic input device 358 allows the electronic device 301 to detect sound waves through a microphone (for example, the microphone 388) through an input device generating ultrasonic signals, and is capable of wireless recognition. According to an embodiment of the present disclosure, the electronic device 301 may receive a user input from an external device connected thereto (for example, a computer, or a server) by using the communication module 320.

The display 360 (e.g., the display 150) may include a panel 362, a hologram device 364, or a projector 366. For example, the panel 362 may be an LCD or an AM-OLED. For example, the panel 362 may be implemented to be flexible, transparent, or wearable. The panel 362 may be configured as a single module along with the touch panel 352. The hologram device 364 may show a stereoscopic image in the air using interference of light. The projector 366 may display an image by projecting light onto a screen. The screen may be located inside or outside the electronic device 301. According to an embodiment of the present disclosure, the display 360 may further include a control circuit to control the panel 362, the hologram device 364, or the projector 366.

The interface 370 may include an HDMI 373, a USB 374, an optical interface 376, or D-subminiature (D-sub) 378. The interface 370 may be included in the communication interface 160 shown in FIG. 1. Additionally or alternatively, the interface 370 may include a Mobile High Definition Link (MHL) interface, an SD/Multimedia Card (MMC) interface or Infrared Data Association (IrDA) standard interface (not shown).

The audio module 380 may convert a sound and an electric signal bidirectionally. For example, at least some elements of the audio module 380 may be included in the input and output interface 140 shown in FIG. 1. The audio module 380 may process sound information which is input or output through a speaker 382, a receiver 384, an earphone 386, or a microphone 388. The camera module 391 is a device for photographing a still image and a moving image, and may include one or more image sensors (for example, a front surface sensor or a rear surface sensor), a lens (not shown), an Image Signal Processor (ISP) (not shown), or a flash (memory) (for example, an LED or a xenon lamp).

The power management module 395 may manage power of the electronic device 301. Although not shown, the power management module 395 may include a Power Management IC (PMIC), a charging IC, or a battery or fuel gage.

For example, the PMIC may be mounted in an integrated circuit or a SoC semiconductor. The charging method may be divided into a wired charging method and a wireless charging method. The charging IC may charge a battery and may prevent inflow of overvoltage or over current from a charger. According to an embodiment of the present disclosure, the charging IC may include a charging IC for at least one of the wired charging method and the wireless charging method. The wireless charging method may include a magnetic resonance method, a magnetic induction method, or an electromagnetic wave method, and an additional circuit for charging wirelessly, for example, a circuit such as a coil loop, a resonant circuit, a rectifier, and the like may be added.

For example, a battery gauge may measure a remaining battery life of the battery 396, a voltage, a current, or temperature during charging. The battery 396 may store or generate electricity and may supply power to the electronic device 301 by using stored or generated electricity. The battery 396 may include a rechargeable battery or a solar battery.

The indicator 397 may display a specific state of the electronic device 301 or a part of it (for example, the AP 310), for example, a booting state, a message state, or a charging state. The motor 398 may convert an electric signal into a mechanical vibration. Although not shown, the electronic device 301 may include a processing device (for example, a GPU) for supporting a mobile TV. The processing device for supporting the mobile TV may process media data according to standards such as Digital Multimedia Broadcasting (DMB), Digital Video Broadcasting (DVB), or media flow.

Each of the above-described elements of the electronic device according to various embodiments of the present disclosure may be comprised of one or more components, and the names of the elements may vary according to a kind of the electronic device. The electronic device according to various embodiments of the present disclosure may include at least one of the above-described elements, and some of the elements may be omitted or an additional element may be further included. In addition, some of the elements of the electronic device according to various embodiments of the present disclosure may be combined into a single entity, and may perform the same functions as those of the elements before being combined.

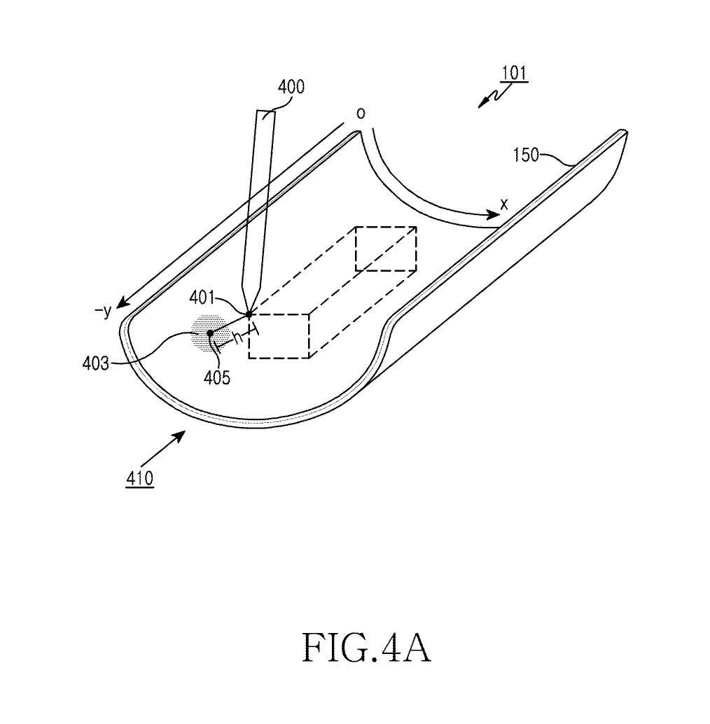

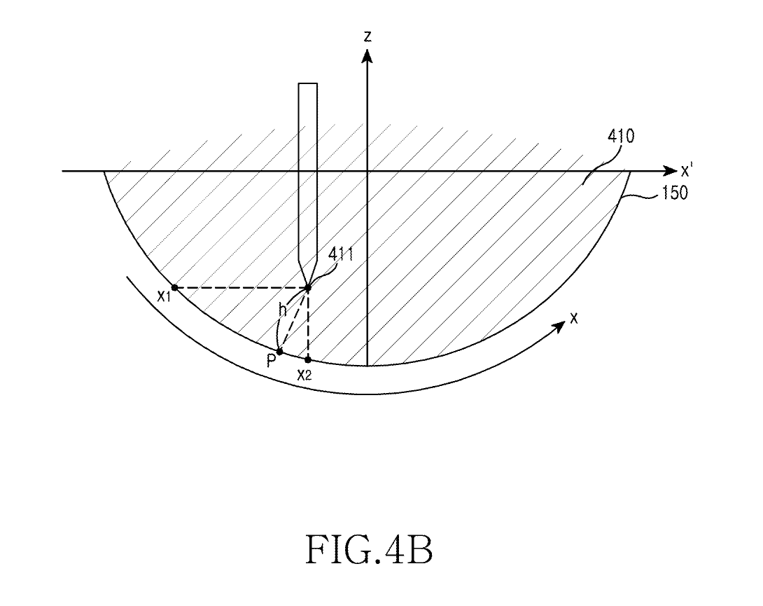

FIGS. 4A and 4B illustrate a method for detecting hovering in a curved display of an electronic device according to various embodiments of the present disclosure.

When an electronic device (e.g., electronic device 101 of FIG. 1) includes a curved display 150, the electronic device 101 may allow a user to input a command in 3 dimensions through a designated location (for example, an end of an inputting means or a designated device which is attached for hovering) of one or more inputting means (for example, a certain finger of the user, an electronic pen, a touch pen, a stylus, and the like) in a designated space formed by the display 150. The display 150 may detect a location of hovering which is made by placing the inputting means in a designated space area which is curved.

Hereinafter, various embodiments of the present disclosure will be explained with reference to FIG. 4A.

Referring to FIG. 4A, the electronic device 101 may have a designated curvature or a curved surface of a designated shape like the display 150. The electronic device 101 may detect an inputting means 400 which approaches to hover above the display 150, and may acquire information on designated coordinates 405 of the display 150 corresponding to a designated location 401 indicated by the hovering of the inputting means 400 and information on a distance between the inputting means 400 and the designated location 401 on the display 150 indicated by the inputting means 400. According to an embodiment of the present disclosure, when the electronic device 101 detects the inputting means 400 hovering in the designated space 403 of the display 150, the electronic device 101 may display coordinates on the space where the inputting means 400 is located as coordinates of a virtual coordinate system (e.g., a coordinate system including an x-axis and a −y-axis) determined on the display 150. The electronic device 101 may acquire designated coordinates 405 corresponding to a motion of the inputting means 400 which hovers in the designated space 403 of the display 150, and may input a 3D object through the display 150 based on the acquired coordinates. The electronic device 101 may allow the inputting means to be placed in the designated space 403 of the display 150, such that inputting a command on an object displayed on the surface of the display 150 is not limited to hovering and the designated space 403 of the display 150 can be used as a 3D input area in which the user can input with the inputting means. Hereinafter, a method for determining information on a location of the inputting means 400 which hovers above the display 150 will be explained with reference to FIG. 4B which is viewed from direction 410.

Hereinafter, various embodiments of the present disclosure will be explained with reference to FIG. 4B.

Referring to FIG. 4B, the electronic device 101 may determine space coordinates of the inputting means 400 in a designated space 410 at a point of time when the inputting means 400 hovers above a designated location of the display 150 based on a coordinate system designated on the display 150 (for example, a coordinate system including an x-axis) and a coordinate system set according to the designated space 410 formed by the display 150 (for example, a coordinate system including an x′-axis and a z-axis). According to an embodiment of the present disclosure, the space coordinates may be coordinates about a designated location of the end of the inputting means from the surface of the display 150 when the end of the inputting means is detected in the hovering of the inputting means detected by the display 150. According to an embodiment of the present disclosure, when the electronic device 101 detects hovering of the inputting means located in the designated space 410 of the display 150, the electronic device 101 may determine a plurality of coordinates of an input which is detected on the surface of the display 150, and may determine a location (for example, a point ‘p’) indicated by the inputting means in a designated method. The above-described method may use a typical method for determining a designated location indicated by the inputting means when the user hovers above the display 150 which detects hovering with the inputting means. The electronic device 101 may determine a distance (for example, a distance ‘h’) to the location of the inputting means from the point ‘p’ of the display 150 based on the determined point ‘p’. The electronic device 101 may determine two or more x-axis coordinates including a −y-axis (for example, a −y-axis set on the display 150 of FIG. 4A) coordinate which is the same as at the point ‘p’ from among the plurality of coordinates determined by detecting hovering of the inputting means above the display 150. The electronic device 101 may determine x-axis coordinates (for example, x1 and x2) corresponding to an intersection point between a line extending from the determined x-axis coordinate in the direction of the x′-axis and/or z-axis set in the designated space 410 of the display 150 and the location 411 of the inputting means which is distanced from the point ‘p’ of the display 150 by the distance ‘h’. The electronic device 101 may determine the coordinates of the location 411 of the inputting means which hovers in the designated space of the display 150 in the form of coordinates designated by the electronic device 101 such as (x1, x2), and/or (x1, x2, h).

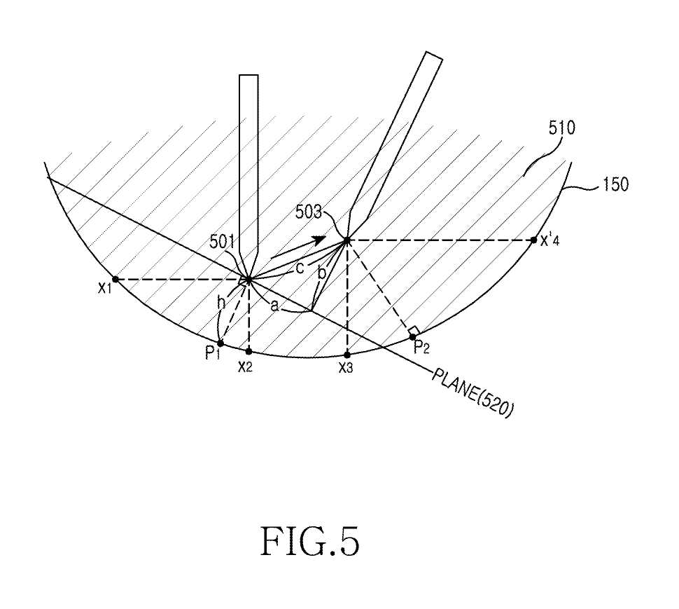

FIG. 5 illustrates a method for detecting space coordinates corresponding to hovering in a curved display of an electronic device according to an embodiment of the present disclosure.

Referring to FIG. 5, the electronic device 101 may determine a location where the inputting means hovers at a certain location in a designated space 510 (which may correspond to the designated space 410 of FIG. 4B) of the display 150. When the inputting means moves while still maintaining hovering, the electronic device 101 may detect a change in hovering input to the display 150 (for example, information on a trajectory).

According to various embodiments of the present disclosure, when the user hovers in the designated space 510 of the display 150 with the inputting means, in the method of FIGS. 4A and 4B, the electronic device 101 may determine an x1 coordinate and an x2 coordinate based on coordinates of a point p1 corresponding to a location 501 of the inputting means in the designated space 510 (for example, an x-axis coordinate and a −y-axis coordinate), and a distance between the point p1 and the location 501. The electronic device 101 may set a virtual plane 520 which is perpendicular to a line extending from the point p1 toward the location 501 with reference to the location 501 in the designated space 510. The electronic device 101 may detect a change (for example, information on a trajectory) in hovering of the inputting means detected at the location 501 with reference to the set plane 520. In detecting the change in the hovering input to the display 150, the electronic device 101 may detect the change when the location of hovering on space coordinates input in a designated time unit and/or by the inputting means is moved by more than a designated distance. According to an embodiment of the present disclosure, the electronic device 101 may determine coordinates of the inputting means changing on the set plane 520 with reference to the designated location 501 of the designated space 510. According to an embodiment of the present disclosure, the electronic device 101 may detect hovering of the inputting means at a certain location 501 of the designated space 510, and, when the inputting means is moved in the designated space 510 of the display 150, may detect hovering of the inputting means corresponding to a changed location 503. The electronic device 101 may determine coordinates of a point p2 indicated by the inputting means according to the changed location 503 and information on a distance from the point p2 to the location 503. The electronic device 101 may determine an x3 coordinate and an x4 coordinate based on the coordinates of the point p2 and the information on the distance from the point p2 to the location 503. The electronic device 101 may determine information (for example, a length ‘a’, a length ‘b’ and/or a length ‘c’) on the change from the location 501 to the location 503 on the set plane 520 (for example, a vector ‘c’) based on the x1 coordinate and the x2 coordinate which are components of the location 501 and the x3 coordinate and the x4 coordinate which are components of the location 503. For example, when the vector ‘c’ regarding the change from the location 501 to the location 503 is determined, the electronic device 101 may determine the vector ‘c’ based on the x1 coordinate, the x2 coordinate, and the coordinate of the −y-axis regarding the location 501 and the x3 coordinate, the x4 coordinate, and the coordinate of the −y-axis regarding the location 503. In an alternative method, the electronic device 101 may determine the length ‘b’ which is perpendicular to the plane 502 according to the change from the location 501 to the location 503 on the set plane 520, and may determine the length ‘a’ from the location 501 to a point on the plane 502 intersecting with the length ‘b’. When the electronic device 101 repeatedly detects the movement of the inputting means in the designated space 510, the electronic device 101 may determine information on the changed location of the inputting means by repeating the above-described method. In the above-described explanation, the electronic device 101 may input space coordinates corresponding to a trajectory drawn in the designated space 510 based on hovering input to the display 150, and may input a 3D image corresponding to the input space coordinates. In displaying the trajectory input to the display 150 by the inputting means, the electronic device 101 may display at least one space coordinate on the location of the inputting means or may display a line connecting two or more space coordinates.

According to various embodiments of the present disclosure, when there are one or more other methods for determining space coordinates of hovering of the inputting means in the designated space 510 and space coordinates of hovering of the moved inputting means, the electronic device 101 may correct the space coordinates determined based on the method described with reference to FIG. 5.

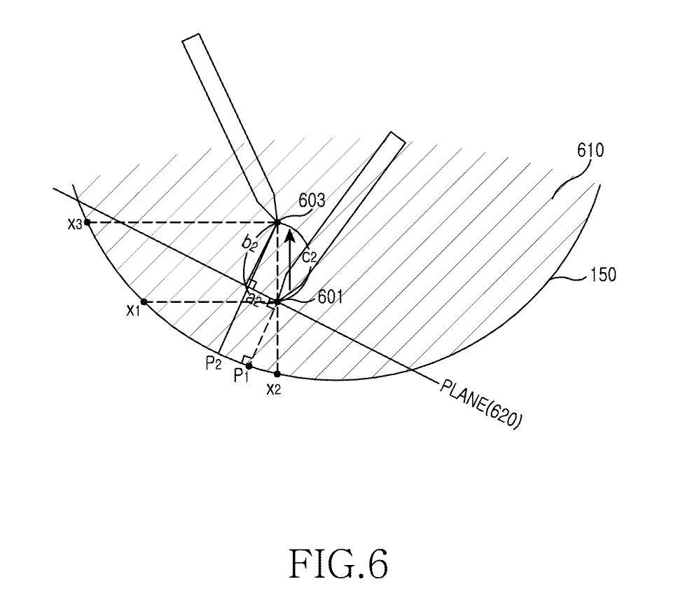

FIG. 6 illustrates a method for detecting space coordinates corresponding to hovering in a curved display of an electronic device according to an embodiment of the present disclosure.

Referring to FIG. 6, the electronic device 101 may determine space coordinates of a location 601 where the inputting means hovers in a designated space 610 of the display 150, and may determine a plane 620 with reference to the location 601 in the method described above with reference to FIG. 5. In the method described above with reference to FIG. 5, the electronic device 101 may determine an x1 coordinate and an x2 coordinate of the location 601, and, when the inputting means moves from the location 601 of hovering and the location of the hovering changes (for example, to a location 603), the electronic device 101 may determine an x3 coordinate and an x2 coordinate in the method described above with reference to FIG. 5. When at least one of the x-axis coordinates constituting the location 601 and the location 603 is consistent with each other (for example, the x2 coordinate), the electronic device 101 may determine a length (for example, a length c2) by which the inputting means is moved along a designated axis (an z-axis in the case of FIG. 4B) based on the other coordinates (for example, the x1 coordinate and the x3 coordinate). According to various embodiments of the present disclosure, the electronic device 101 may determine a perpendicular length b2 from the location 603 of the designated space 610 to the plane 620 which is set with reference to the location 601, and determine a length a2 from the location 601 of the plane 620 to the location at which the perpendicular length b2 intersects the plane 620. The electronic device 101 may determine the length c2 based on the determined length a2 and length b2.

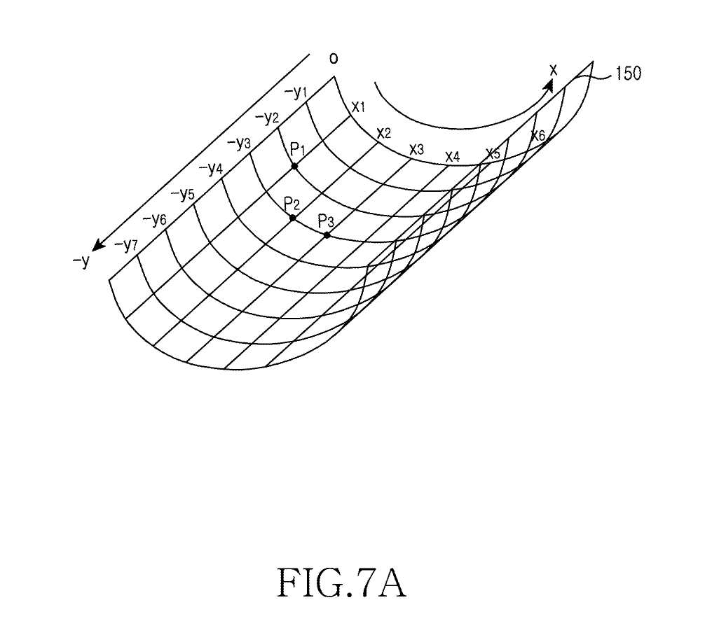

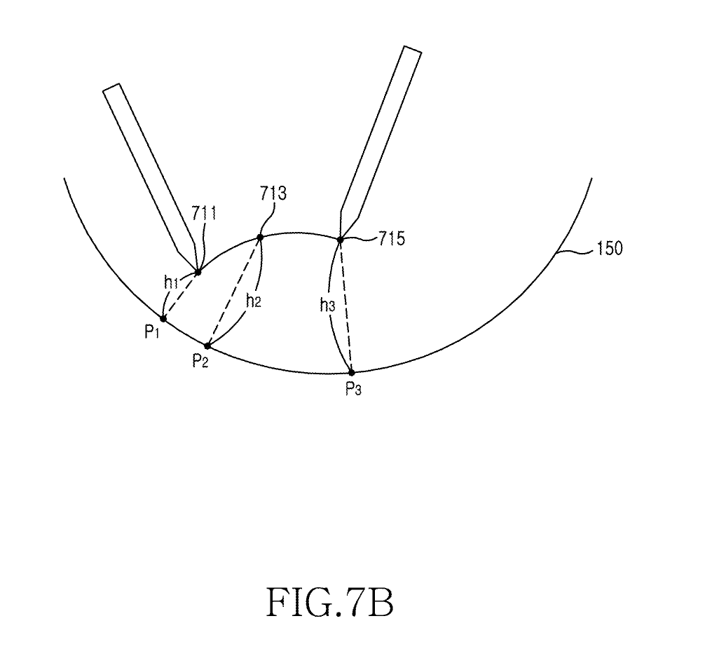

FIGS. 7A and 7B illustrate a method for detecting space coordinates corresponding to hovering when coordinates are designated on a display of an electronic device according to various embodiments of the present disclosure.

When the user hovers above the display 150 with the inputting means, the electronic device 101 may determine space coordinates of a location where the inputting means hovers in a designated space (for example, the space 610 of FIG. 6) which is formed by the display 150 based on a coordinate system designated on the display 150 and a distance from the inputting means to the display 150.

Hereinafter, various embodiments of the present disclosure will be explained with reference to FIG. 7A.

Referring to FIG. 7A, the electronic device 101 may set at least one coordinate system with reference to a designated location of the curved display 150. The electronic device 101 may determine coordinates corresponding to a gap designated on the screen surface of the display 150 based on the coordinate system set on the display 150. When the user hovers a predetermined distance away from the curved display 150 with the inputting means, the electronic device 101 may determine coordinates corresponding to a location indicated by the inputting means (for example, coordinates of a point p1) based on the coordinate system on for the display 150. When the electronic device 101 sets a coordinate system including an x-axis and a −y-axis on the display 150, the electronic device 101 may determine a designated location of the display 150 indicated by the inputting means which is hovering above the display 150 as a point p1, and may determine coordinates of the point p1 as (x1, −y2) by referring to the coordinate system set on the display 150.

Hereinafter, various embodiments of the present disclosure will be explained with reference to FIG. 7B.

Referring to FIG. 7B, when the inputting means hovers, indicating a designated location of the display 150, the electronic device 101 may determine space coordinates of the location where the inputting means hovers based on coordinates on the screen surface of the display 150 corresponding to the input of the inputting means (for example, coordinates of the point p1, p2, or p3, points p1, p2, and p3 of FIG. 7A), and a length from the coordinates corresponding to the input of the inputting means to the inputting means. According to an embodiment of the present disclosure, when the inputting means is placed at a location 711, the electronic device 101 may determine that the inputting means indicates the point p1 of the display 150 (point p1 of FIG. 7A), and may determine coordinates corresponding to the point p1 (for example, coordinates (x1, −y2)). Furthermore, the electronic device 101 may determine a length ‘h1’ from the point p1 of the display 150 to the inputting means, and determine space coordinate (for example, space coordinates including an x-axis value, a −y-axis value, and an ‘h’ value) of the location 711 of the inputting means as (x1, −y2, h1).

The electronic device 101 may determine the space coordinates corresponding to the location 711 of the inputting means, and may detect the inputting means moving in the designated space of the display 150. According to an embodiment of the present disclosure, when the inputting means hovering above the designated location 711 of the designated space formed by the display 150 is moved to a designated location 713, the electronic device 101 may detect the movement of the inputting means. The electronic device 101 may determine coordinates (x2, −y3) of the location indicated by the inputting means on the screen of the display 150 (for example, the point p2), and may determine a length ‘h2’ from the point p2 of the screen of the display 150 to the inputting means. The electronic device may determine space coordinates corresponding to the location 713 as (x2, −y3, h2). The electronic device 101 may input a trajectory corresponding to the movement of the inputting means from the space coordinates of the point p1 to the space coordinates of the point p2 in the designated space which is determined based on the display 150, and may display the trajectory on the display 150 based on the acquired space coordinates. In displaying the acquired trajectory of the inputting means on the display 150, the electronic device 101 may display the trajectory as an image like a hologram based on the acquired space coordinates. Furthermore, the electronic device 101 may display the acquired trajectory of the inputting means as a hologram.

The electronic device 101 may detect the inputting means which moves to a designated location 715 while still maintain the hovering at the designated location 713 in the designated space formed by the display 150. The electronic device 101 may acquire space coordinates corresponding to the location 715 in the above-described method, input a trajectory corresponding to the movement of the inputting means passing through the points p1, p2, and p3 based on the acquired space coordinates, and display the trajectory of the inputting means which is acquired based on the points p1, p2, and p3 on the display 150 of the electronic device 101. In acquiring space coordinates corresponding to a movement of the inputting means hovering in a designated space (for example, 610 of FIG. 6) formed by the display 150, the electronic device 101 may detect space coordinates corresponding to the inputting means which hovers above the display 150 at designated time intervals. The electronic device 101 may display the acquired space coordinates on a designated location of a 3D space displayed on the display 150.

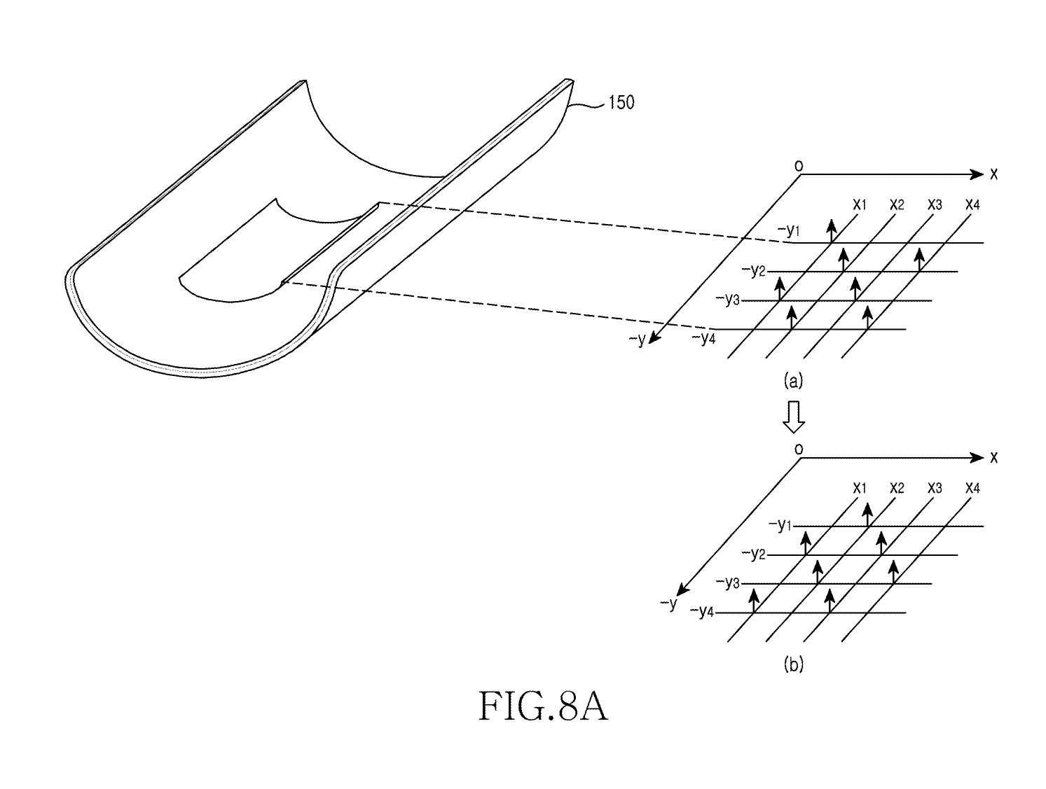

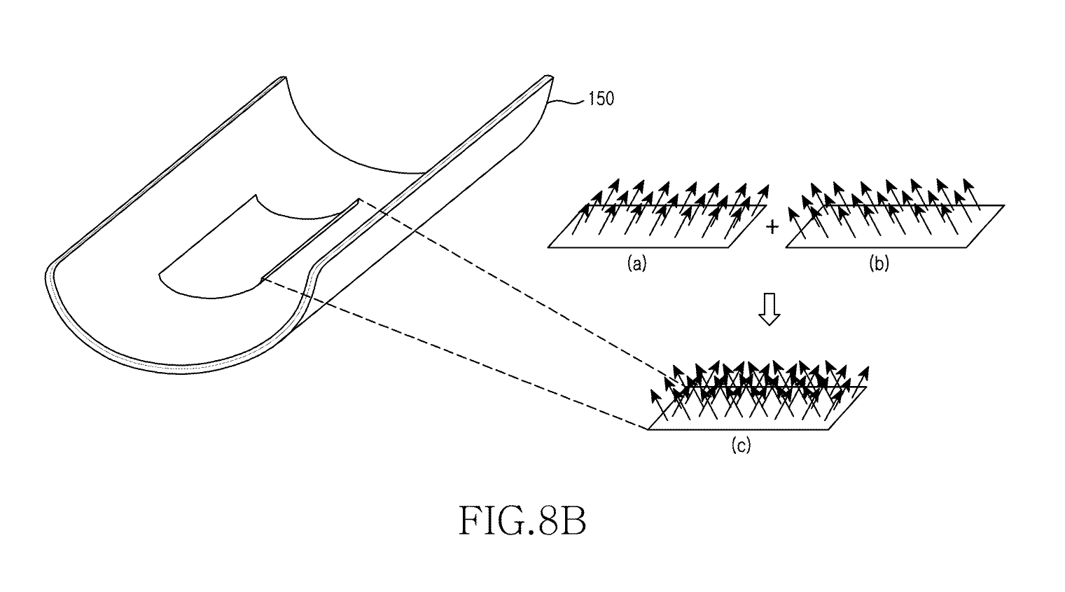

FIGS. 8A and 8B illustrate a configuration of a device for determining space coordinates of an inputting means when the inputting means is located in a designated space formed by a display of an electronic device according to various embodiments of the present disclosure.

Hereinafter, various embodiments of the present disclosure will be explained with reference to FIG. 8A.

Referring to FIG. 8A, the electronic device 101 may use signals of different patterns in transmitting a transmission signal to detect hovering at the display 150 which detects hovering. According to an embodiment of the present disclosure, a first cycle of the transmission signal to detect space coordinates of the inputting means which is placed away from the screen surface of the display 150 by a designated length may include transmitting signals two times (a first signal and a second signal). In transmitting the first signal, the electronic device 101 may divide a signal transmission device of a grid pattern into two or more patterns as shown in views (a) and (b) of FIG. 8A, and completes the first cycle by transmitting signals of the determined patterns in a designated order. The electronic device 101 may receive the first signal and the second signal which are changed by hovering of the inputting means at a signal receiving device of the display 150, and may compare the changed first signal and the changed second signal to acquire a difference therebetween. The electronic device 101 may determine space coordinates of the inputting means located in a designated space formed by the display 150 based on a result of the comparing. In inputting the space coordinates of the location of the inputting means, the electronic device 101 may display a sense of depth which is formed based on the changed first signal and the changed second signal on the display 150.

Hereinafter, various embodiments of the present disclosure will be explained with reference to FIG. 8B.

Referring to FIG. 8B, the electronic device 101 may use two or more signal transmission devices which transmit different signals for detecting hovering at the display 150. According to an embodiment of the present disclosure, in the electronic device 101, two or more signal transmission devices having different signal transmission angles as shown in views (a) and (b) of FIG. 8B overlap with each other in the display 150 to output transmission signals of designated patterns as shown in view (c) of FIG. 8B. The electronic device 101 may acquire a first signal which is changed from a signal transmitted from the signal transmission device of view (a) of FIG. 8B by the inputting means, and a second signal which is changed from a signal transmitted from the signal transmission device of view (b) of FIG. 8B by the inputting means at the signal receiving device of the display 150. The electronic device 101 may acquire space coordinates of the inputting means which is placed away from the screen surface of the display 150 by a designated length by comparing the first signal and the second signal. In inputting the space coordinates of the location of the inputting means, the electronic device 101 may display a sense of depth which is formed based on the first signal and the second signal on the display 150.

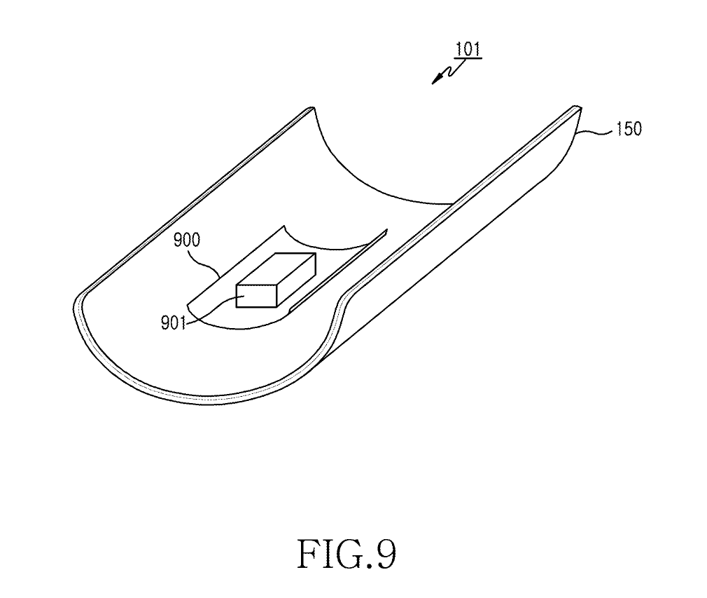

FIG. 9 illustrates an operation of displaying a trajectory which is drawn by space coordinates input through a display of an electronic device according to an embodiment of the present disclosure.

Referring to FIG. 9, the electronic device 101 may display space coordinates corresponding to a hovering location of the inputting means which is acquired through the display 150 through at least one display device included in the electronic device 101 (for example, the display 150), and, when the hovering location of the inputting means above the display 150 is changed, the electronic device 101 may display space coordinates corresponding to the changed location and an input corresponding to a moving trajectory of the inputting means on at least one display device included in the electronic device 101 (for example, the display 150). According to an embodiment of the present disclosure, when the electronic device 101 displays the space coordinates of the location of the inputting means and the moving trajectory of the inputting means on the display 150, the electronic device 101 may display an area 900 where two or more dimensions can be represented like a designated space of the display 150 (for example, the designated space 610 of FIG. 6 which is formed by the display 150). The electronic device 101 may display an image 901 corresponding to the space coordinates acquired through the inputting means and the trajectory of the inputting means on the area 900 displayed on the display 150. The electronic device 101 may display the image 901 on the display 150 so that the image 901 can be viewed as a 3D image according to rotation, or may display the image 901 as a hologram. According to various embodiments of the present disclosure, the electronic device 101 may display space coordinates which are input in three dimensions by the input means hovering in the space formed by the display 150 and a trajectory which is determined by two or more space coordinates on the display 150 in three dimensions or with a sense of 3D space.

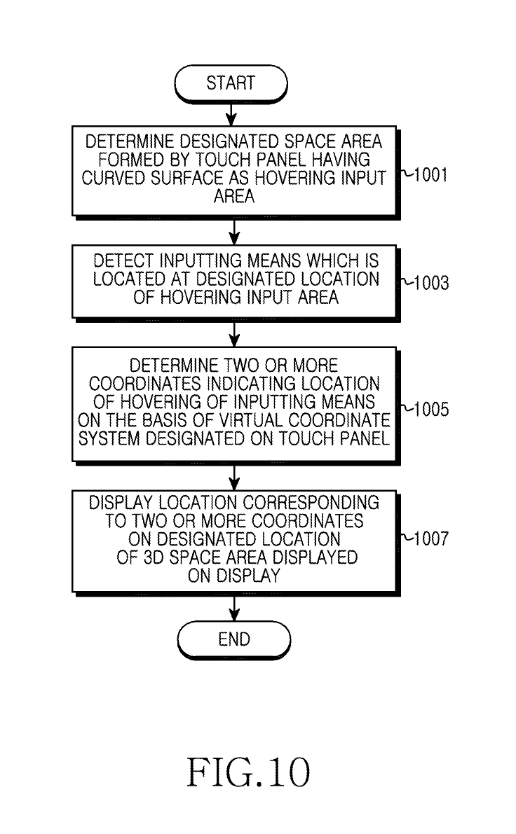

FIG. 10 is a flowchart showing an operation of processing hovering which is input to a space formed by a display of an electronic device according to an embodiment of the present disclosure.

Referring to FIG. 10, the electronic device 101 may control the display 150 to determine a designated space (for example, the designated space 610 of FIG. 6) formed by the curved display 150 in operation 1001. According to an embodiment of the present disclosure, the electronic device 101 may have a curvature of the display 150 changed by the user, and may control (or set) a hovering processing method of the display 150 according to the changed curvature.

In operation 1003, the electronic device 101 may detect hovering of the inputting means which is located in the designated space (for example, the designated space 610 of FIG. 6) of the display 150. According to an embodiment of the present disclosure, the electronic device 101 may determine coordinates on a designated location of the display 150 indicated by the inputting means which is hovering, and may determine a length from a location on a screen surface corresponding to the coordinates of the display 150 to the inputting means.

In operation 1005, the electronic device 101 may determine space coordinates corresponding to the location of the inputting means based on the coordinates of the inputting means which is hovering above the display 150 and the length. According to an embodiment of the present disclosure, when the electronic device 101 sets an x-axis and −y-axis coordinate system on the screen of the display 150, the electronic device 101 may determine two or more coordinates along the x-axis (for example, the x-axis of FIG. 4B) corresponding to the curved surface of the display 150 (for example, values of the −y-axis may be equal to each other), and may determine a length from the designated location of the display 150 to the inputting means based on the determined two or more coordinates.

In operation 1007, the electronic device 101 may display the space coordinates corresponding to the location of the inputting means which hovers above the display 150 on the display 150. When the inputting means is moved while the electronic device 101 displays the space coordinates on the display 150, the electronic device 101 may display a trajectory of the moving input means on the display 150 in three dimensions. According to an embodiment of the present disclosure for displaying in three dimensions, the electronic device 101 may display a space area designated to display a 3D image on the display 150, and may display the acquired space coordinates on the designated space area. The electronic device 101 may rotate the space area displayed on the display 150 under the control of the user, and may represent a sense of depth on the space coordinates displayed on the space area by the rotation.

The electronic device 101 may finish the embodiment of FIG. 10 after operation 1007 is performed.

According to an aspect of the present disclosure, a method for operating of an electronic device comprises detecting hovering which is input to a touch panel comprising a curved surface, determining space coordinates corresponding to the hovering, and displaying an image corresponding to the space coordinates on a display. The detecting of the hovering may include detecting an inputting means which is located in a designated space area formed based on the touch panel, or a change in a location of the inputting means. The space coordinates are determined based on at least one coordinate located on a coordinate system set on the touch panel, and a length from a surface of the touch panel to the inputting means. The space coordinates are determined based on two or more coordinates which have a same corresponding value on at least one coordinate axis in a coordinate system set on the touch panel. The determining the space coordinates comprises setting a virtual plane having at least one coordinate axis with reference to the space coordinate in a designated space formed by the touch panel. The determining the space coordinates comprises, when the inputting means which hovers is moved, determining a location of the moved inputting means according to displacement in a coordinate system set on the plane with reference to the space coordinates. The displaying the image comprises displaying the space coordinates corresponding to an input of the inputting means as a 3D image or a hologram. The determining the space coordinates may include transmitting a first signal and a second signal through the touch panel, receiving a third signal and a fourth signal which are changed from the first signal and the second signal by the inputting means, respectively, through the touch panel, and comparing the third signal and the fourth signal to determine a gap between the third signal and the fourth signal. The transmitting may include transmitting the first signal and the second signal which are of different patterns serially. The transmitting may include transmitting the first signal at a first angle and transmitting the second signal at a second angle.

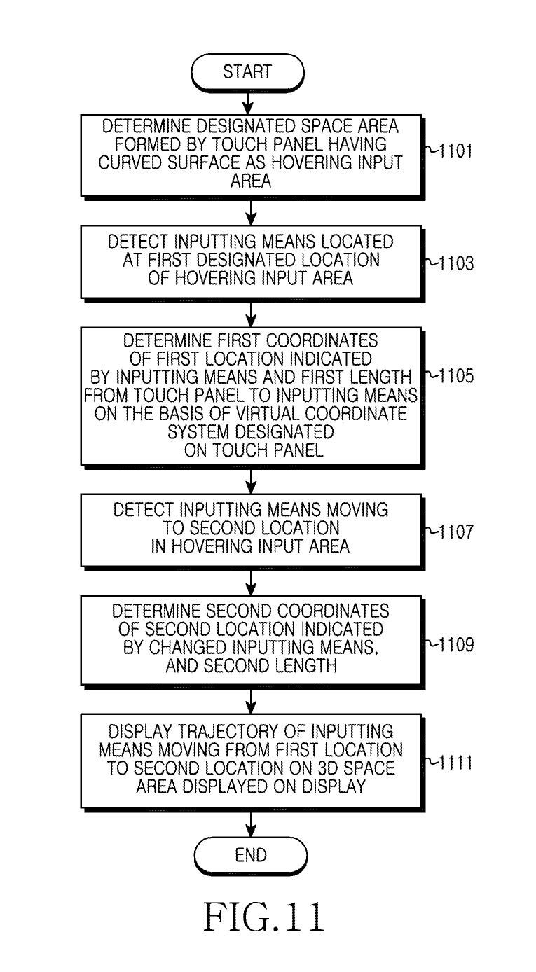

FIG. 11 is a flowchart showing an operation of processing hovering which is input to a space formed by a display of an electronic device according to various embodiments of the present disclosure.

Referring to FIG. 11, the electronic device 101 may control to determine the designated space area of the display 150 in operation 1101. According to an embodiment of the present disclosure, the electronic device 101 may detect the inputting means which is located in a designated space formed by the curved display 150, set one or more coordinate axes on the display 150 or the designated space of the display 150 to determine space coordinate of the location of the inputting means, and determine a hovering area.

In operation 1103, the electronic device 101 may detect the inputting means which hovers in the hovering area.

In operation 1105, the electronic device 101 may determine space coordinates corresponding to a first location of the inputting means which hovers in the hovering area. According to an embodiment of the present disclosure, the electronic device 101 may determine first coordinates corresponding to a location indicated by the inputting means which hovers in the hovering area, and determine a first length from the screen corresponding to the coordinates of the display 150 to the inputting means. The electronic device 101 may determine first space coordinates of the inputting means located in the hovering area based on the determined first coordinates and first length.

In operation 1107, the electronic device 101 may detect the inputting means which moves to a second location while hovering in the hovering area.

In operation 1109, the electronic device 101 may determine second coordinates of the display 150 indicated by the inputting means which hovers at the second location in the hovering area, and a second length from the screen of the second coordinates to the inputting means. The electronic device 101 may determine second space coordinates of the inputting means located in the hovering area based on the determined second coordinates and second length.

In operation 1111, the electronic device 101 may display the first space coordinates corresponding to the first location and the second space coordinates corresponding to the second location on the display 150, and may display a trajectory of the inputting means moving from the first location to the second location. In displaying the trajectory corresponding to the movement of the inputting means, the electronic device 101 may display third space coordinates corresponding to one or more third locations of the inputting means which are acquired while the inputting means is moved. In displaying the first space coordinates, the second space coordinates, and the trajectory of the movement of the inputting means on the display 150, the electronic device 101 may display a 3D space area corresponding to the hovering area on the display 150 and may display the first space coordinates, the second space coordinates, and the trajectory of the movement of the inputting means in the 3D space area. According to an embodiment of the present disclosure, the electronic device 101 may display the first space coordinates, the second space coordinates, and the trajectory of the movement of the inputting means as holograms.

The electronic device 101 may finish the embodiment of FIG. 11 after operation 1111 is performed.

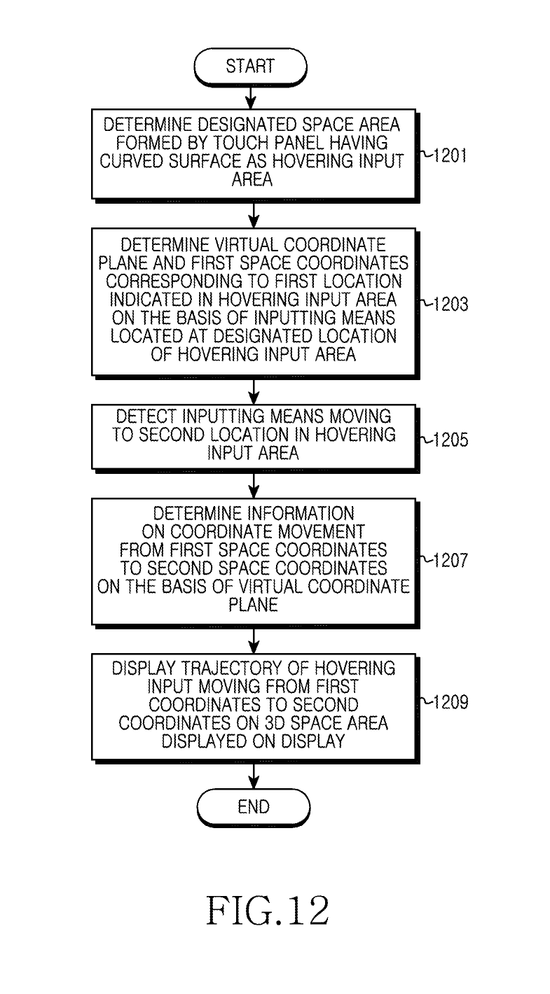

FIG. 12 is a flowchart showing an operation of processing hovering which is input to a space formed by a display of an electronic device according to various embodiments of the present disclosure.

Referring to FIG. 12, the electronic device 101 may control to determine the designated space area of the display 150 in operation 1201. According to an embodiment of the present disclosure, the electronic device 101 may detect the inputting means which is located in a designated space formed by the curved display 150, set one or more coordinate axes on the display 150 or the designated space of the display 150 to determine space coordinate of a location of the inputting means, and determine a hovering area.

In operation 1203, the electronic device 101 may determine at least one plane in the hovering area based on the inputting means which is located in the hovering area. According to an embodiment of the present disclosure, when the electronic device 101 detects the inputting means which is located on a first location of the hovering area, the electronic device 101 may determine first space coordinates corresponding to the first location and may determine a virtual plane according to an angle (for example, a right angle) which is designated with reference to a segment connecting the inputting means and the designated location of the display 150 indicated by the inputting means (for example, the electronic device 101 may set a 3D coordinate system based on a plane). The electronic device 101 may determine the location of the inputting means on the set plane as a reference point (for example, coordinates (0, 0, 0) in the case of a 3D coordinate system).

In operation 1205, the electronic device 101 may detect the inputting means which moves to a second location while still maintaining hovering in the hovering area.

In operation 1207, the electronic device 101 may determine displacement in a set coordinate system from the reference point (for example, the first location) of the set plane to the second location. In determining the displacement from the first location to the second location, the electronic device 101 may determine space coordinates corresponding to the second location in the hovering area.

In operation 1209, the electronic device 101 may display the first coordinates, the second coordinates, and a trajectory of the inputting means moving from the first coordinates to the second coordinates on the display 150. In displaying the trajectory corresponding to the movement of the inputting means, the electronic device 101 may display displacement from the first location to one or more third locations of the inputting means which are acquired while the inputting means is moved, and/or space coordinates of the third location. In displaying the first coordinates, the second coordinates, and the trajectory of the inputting means moving from the first coordinates to the second coordinates on the display 150, the electronic device 101 may display a 3D space area corresponding to the hovering area on the display 150 and may display the first coordinates, the second coordinates, and the trajectory of the inputting means moving from the first coordinates to the second coordinates on the displayed 3D space area. According to an embodiment of the present disclosure, the electronic device 101 may display the first coordinates, the second coordinates, and the trajectory of the movement of the inputting means from the first coordinates to the second coordinates as holograms.

The electronic device may input an image that the user intends to input in three dimensions by allowing the user to hover in a designated space formed by the display having a curved surface.

While the data management module performs the operations above, they may be performed under the control of the processor 120. Further, the data management module which is programmed to control various embodiments of the present disclosure may be separated from the processor 120. The data management module programmed to control various embodiments of the present disclosure may operate under the control of the processor 120.

According to an aspect of the present disclosure, an electronic device comprises a touch panel configured to detect hovering, a display configured to display space coordinates corresponding to the hovering, a memory configured to store information on the hovering; and at least one processor configured to detect the hovering which is input to the touch panel comprising a curved surface, determine the space coordinates corresponding to the hovering, and display an image corresponding to the space coordinates on the display. The processor may be configured to control to detect an inputting means which is located in a designated space area formed based on the touch panel, or a change in a location of the inputting means. The processor may be configured to determine the space coordinates based on at least one coordinate located on a coordinate system set on the touch panel, and a length from a surface of the touch panel to the inputting means. The processor may be configured to determine the space coordinates based on two or more coordinates which have a same corresponding value on at least one coordinate axis in a coordinate system set on the touch panel. The processor may be configured to set a virtual plane having at least one coordinate axis with reference to the space coordinate in a designated space formed by the touch panel. The processor may be configured to, when the inputting means which hovers is moved, determine a location of the moved inputting means according to displacement in a coordinate system set on the plane with reference to the space coordinates. The processor may be configured to display the space coordinates included in the image and corresponding to an input of the inputting means as a 3D image or a hologram. The processor may be configured to determine the space coordinates by transmitting a first signal and a second signal through the touch panel, receiving a third signal and a fourth signal which are changed from the first signal and the second signal by the inputting means, respectively, through the touch panel, and comparing the third signal and the fourth signal to determine a gap between the third signal and the fourth signal. The processor may be configured to transmit the first signal and the second signal which are of different patterns serially. The processor may be configured to transmit the first signal at a first angle and transmit the second signal at a second angle.

At least part of an apparatus and method based on the embodiments disclosed in the claims and/or specification of the present disclosure can be implemented in the form of hardware, software, firmware, or a combination of two or more of the hardware, software, and firmware (e.g., in the form of a module or unit). The module refers to a minimum unit of an integrally configured component or a part of it and may be a minimum unit for performing various embodiments of the present disclosure or a part of it. The module may be mechanically or electronically implemented. When implemented in software, a computer readable storage medium for storing one or more programs (or a programming module) can be provided. For example, the software may be implemented by using instructions stored in a computer readable storage medium in the form of a programming module. One or more programs include instructions for allowing the electronic device to execute the methods based on the embodiments disclosed in the claims and/or specification of the present disclosure. When the instructions are executed by one or more processors (e.g., the processor 120), the one or more processors may perform a function corresponding to the instructions. The computer readable storage medium may be the memory 130, for example. At least part of the programming module may be implemented (e.g., executed) by using the processor 120. At least part of the programming module may include a module, a program, a routine, sets of instructions, a process, and the like for performing one or more functions.

Examples of the computer-readable recording medium include magnetic media such as hard disks, floppy disks and magnetic tapes, optical media such as Compact Disc ROMs (CD-ROMs) and DVDs, magneto-optical media such as floptical disks, hardware devices such as ROMs, RAMs and flash memories that are especially configured to store and execute program commands (e.g., the programming module), and EEPROMs, magnetic disc storage devices or other type of optical storage devices, and magnetic cassettes. Alternatively, the program can be stored in a memory configured in combination of all or some of these storage media. In addition, the configured memory may be plural in number.

Further, the program can be stored in an attachable storage device capable of accessing the electronic device through a communication network such as the Internet, an Intranet, a Local Area Network (LAN), a Wide LAN (WLAN), or a Storage Area Network (SAN) or a communication network configured by combining the networks. The storage device can access via an external port to the electronic device. In addition, a separate storage device on the communication network can access a portable electronic device. The above-described hardware devices may be configured to operate as one or more software modules for performing operations of various embodiments of the present disclosure, and vice versa.

A module or programming module according to various embodiments of the present disclosure may include one or more of the above-described elements, may omit some elements, or may further include additional elements. The operations performed by the module, the programming module, or the other elements according to various embodiments of the present disclosure may be performed serially, in parallel, repeatedly, or heuristically. In addition, some operation may be performed in different order or may omitted, and an additional operation may be added.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for operating of an electronic device, the method comprising:
detecting hovering which is input to a touch panel comprising a curved surface;
determining space coordinates corresponding to the hovering; and
displaying an image corresponding to the space coordinates on a display.

2. The method of claim 1, wherein the detecting of the hovering comprises detecting an inputting means which is located in a designated space area formed based on the touch panel, or a change in a location of the inputting means.

3. The method of claim 1, wherein the space coordinates are determined based on at least one coordinate located on a coordinate system set on the touch panel, and a length from a surface of the touch panel to the inputting means.

4. The method of claim 1, wherein the space coordinates are determined based on two or more coordinates which have a same corresponding value on at least one coordinate axis in a coordinate system set on the touch panel.

5. The method of claim 1, wherein the determining of the space coordinates comprises setting a virtual plane having at least one coordinate axis with reference to the space coordinate in a designated space formed by the touch panel.

6. The method of claim 5, wherein the determining of the space coordinates comprises, when the inputting means which hovers is moved, determining a location of the moved inputting means according to displacement in a coordinate system set on the plane with reference to the space coordinates.

7. The method of claim 1, wherein the displaying of the image comprises displaying the space coordinates corresponding to an input of the inputting means as a three-dimensional (3D) image or a hologram.

8. The method of claim 1, wherein the determining of the space coordinates comprises:
transmitting a first signal and a second signal through the touch panel;
receiving a third signal and a fourth signal which are changed from the first signal and the second signal by the inputting means, respectively, through the touch panel; and
comparing the third signal and the fourth signal to determine a gap between the third signal and the fourth signal.

9. The method of claim 8, wherein the transmitting comprises transmitting the first signal and the second signal which are of different patterns serially.

10. The method of claim 8, wherein the transmitting comprises transmitting the first signal at a first angle and transmitting the second signal at a second angle.

11. An electronic device comprising:
a touch panel configured to detect hovering;
a display configured to display space coordinates corresponding to the hovering;
a memory configured to store information on the hovering; and
at least one processor configured to detect the hovering which is input to the touch panel comprising a curved surface, determine the space coordinates corresponding to the hovering, and display an image corresponding to the space coordinates on the display.

12. The electronic device of claim 11, wherein the processor is further configured to control to detect an inputting means which is located in a designated space area formed based on the touch panel, or a change in a location of the inputting means.

13. The electronic device of claim 11, wherein the processor is further configured to determine the space coordinates based on at least one coordinate located on a coordinate system set on the touch panel, and a length from a surface of the touch panel to the inputting means.

14. The electronic device of claim 11, wherein the processor is further configured to determine the space coordinates based on two or more coordinates which have a same corresponding value on at least one coordinate axis in a coordinate system set on the touch panel.

15. The electronic device of claim 11, wherein the processor is further configured to set a virtual plane having at least one coordinate axis with reference to the space coordinate in a designated space formed by the touch panel.

16. The electronic device of claim 15, wherein the processor is further configured to, when the inputting means which hovers is moved, determine a location of the moved inputting means according to displacement in a coordinate system set on the plane with reference to the space coordinates.

17. The electronic device of claim 11, wherein the processor is further configured to display the space coordinates included in the image and corresponding to an input of the inputting means as a three-dimensional (3D) image or a hologram.

18. The electronic device of claim 11, wherein the processor is further configured to determine the space coordinates by transmitting a first signal and a second signal through the touch panel, receiving a third signal and a fourth signal which are changed from the first signal and the second signal by the inputting means, respectively, through the touch panel, and comparing the third signal and the fourth signal to determine a gap between the third signal and the fourth signal.

19. The electronic device of claim 18, wherein the processor is further configured to transmit the first signal and the second signal which are of different patterns serially.

20. The electronic device of claim 18, wherein the processor is further configured to transmit the first signal at a first angle and transmit the second signal at a second angle.
